(19) United States
(12) Patent Application Publication
(10) Pub. No.: US 2026/0100292 A1
(43) Pub. Date: Apr. 9, 2026

(54) MEDICAL SYSTEMS, ANTI-SCATTER GRIDS AND METHODS OF MANUFACTURING ANTI-SCATTER GRIDS

(71) Applicant: Siemens Healthineers International AG, Steinhausen (CH)

(72) Inventor: Mathias STAMMEIER, Zurich (CH)

(73) Assignee: Siemens Healthineers International AG, Steinhausen (CH)

(21) Appl. No.: 18/905,427

(22) Filed: Oct. 3, 2024

(51) Int. Cl. G21K 1/06

(52) U.S. Cl. CPC G21K 1/06; G21K 2201/067

(57) ABSTRACT

One or more example embodiments provides a method of manufacturing an anti-scatter grid comprising generating a plurality of channels in a substrate using a laser, the substrate including an x-ray transmitting material; and filling the plurality of channels with an x-ray absorber material. One or more example embodiments provides an anti-scatter apparatus comprising a substrate including an x-ray transmitting material, the x-ray transmitting material including at least one of borosilicate glass or fused silica glass, the substrate defining a plurality of channels therein; and an x-ray absorbing material in the plurality of channels.

### TECHNICAL FIELD

Example embodiments relate to medical systems, anti-scatter grids and methods of manufacturing anti-scatter grids.

### BACKGROUND

In medical x-ray applications, a patient is irradiated with x-ray radiation from an x-ray source and the transmitted radiation is detected by an x-ray detector. A fraction of the x-rays is scattered within the patient's body and reaches the detector at different positions and different angles than given by the respective original x-rays, thereby deteriorating the overall image quality. An anti-scatter grid reduces the effect of scattering on image quality.

### SUMMARY

One or more example embodiments relate to an anti-scatter apparatus comprising a substrate including an x-ray transmitting material, the x-ray transmitting material including at least one of borosilicate glass or fused silica glass, the substrate defining a plurality of channels therein; and an x-ray absorbing material in the plurality of channels.

According to one or more example embodiments, the plurality of channels include a first plurality of channels and a second plurality of channels, the first plurality of channels extending along a first axis and the second plurality of channels extending along a second axis.

According to one or more example embodiments, a width of a channel of the plurality of channels is less than 100 μm.

According to one or more example embodiments, the method further includes generating a plurality of channels in a substrate using a laser, the substrate including an x-ray transmitting material; and filling the plurality of channels with an x-ray absorber material.

According to one or more example embodiments, a width of a channel of the plurality of channels is less than 100 μm.

According to one or more example embodiments, the width of the channel of the plurality of channels is less than 50 μm.

According to one or more example embodiments, the substrate includes a glass.

According to one or more example embodiments, the glass includes at least one of borosilicate glass or fused silica glass.

According to one or more example embodiments, the generating includes at least one of inverse laser-drilling to form a plurality of grooves in the substrate; or applying laser pulses to form the plurality of grooves in the substrate.

According to one or more example embodiments, the generating includes the applying the laser pulses and further includes wet etching the plurality of grooves to form the plurality of channels.

According to one or more example embodiments, the filling includes filling the plurality of channels with the x-ray absorber material in a solid form; melting the solid x-ray absorber material; and subsequently solidifying the melted x-ray absorber material.

According to one or more example embodiments, the filling includes filling the plurality of channels with the x-ray absorber material in a solid form; and sealing the plurality of channels after the filing the plurality of channels with the x-ray absorber material in the solid form.

According to one or more example embodiments, the x-ray absorber material in the solid form is a powder.

According to one or more example embodiments, the filling includes casting the x-ray absorber material in a liquid form into the plurality of channels.

According to one or more example embodiments, the filling further includes applying an external pressure during the casting.

According to one or more example embodiments, the filling fills each of the plurality of channels with a lamellae of the x-ray absorber material, a thickness of each lamellae corresponding to a width of the plurality of channels.

One or more example embodiments relate to a medical system comprising a radiation source configured to transmit radiation to a subject; a radiation detector configured to detect at least a portion of the transmitted radiation; and an anti-scatter grid, the anti-scatter grid including, a substrate including an x-ray transmitting material to permit the portion of the transmitted radiation to reach the radiation detector, the x-ray transmitting material including at least one of borosilicate glass or fused silica glass, the substrate defining a plurality of channels therein, and an x-ray absorbing material in the plurality of channels.

One or more example embodiments relate to a method of manufacturing an anti-scatter apparatus, the method comprising generating a plurality of channels in a substrate using wire sawing, the substrate including an x-ray transmitting material; and filling the plurality of channels with an x-ray absorber material.

### BRIEF DESCRIPTION OF THE DRAWINGS

Other objects and features will become apparent from the following detailed description considered in conjunction with the accompanying drawings.

The drawings, however, are only examples and schematic solely for the purpose of illustration and do not limit example embodiments. In the drawings:

FIG. 1 illustrates a method of manufacturing an anti-scatter grid according to one or more example embodiments;

FIG. 2 illustrates a method of filling a plurality of channels in a substrate according to one or more example embodiments;

FIG. 3 illustrates another method of filling a plurality of channels in a substrate according to one or more example embodiments;

FIG. 4A illustrates another method of filling a plurality of channels in a substrate according to one or more example embodiments;

FIG. 4B illustrates a system for performing the method shown in in FIG. 4A according to one or more example embodiments;

FIG. 5 illustrates a medical system according to one or more example embodiments;

FIG. 6A illustrates a top view of a one-dimensional anti-scatter grid according to one or more example embodiments;

FIG. 6B illustrates a top view of a one-dimensional anti-scatter grid according to one or more example embodiments;

FIG. 7 illustrates a cross-sectional view of the anti-scatter grid without an x-ray absorbing material, according to one or more example embodiments;

FIG. 8 illustrates a method of filling the anti-scatter grid shown in FIG. 5 with the x-ray absorbing material, according to one or more example embodiments; and FIG. 9 illustrates a top view of a two-dimensional anti-scatter grid according to one or more example embodiments.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

When the words “about” and “substantially” are used in this application in connection with a numerical value, it is intended that the associated numerical value include a tolerance of ±10% around the stated numerical value, unless otherwise explicitly defined. Further, regardless of whether numerical values are modified as “about” or “substantially,” it will be understood that these values should be construed as including a of ±10% around the stated numerical value.

Independent of the grammatical term usage, individuals with male, female or other gender identities are included within the term.

Anti-scatter grids reduce the effect of scattering on image quality. Large anti-scatter grids are conventionally fabricated by creating an alternating structure of thin x-ray-absorbing lamellae (e.g., made of lead) and x-ray-transmitting lamellae (e.g., made of fiber) that are fixed together with glue. This conventional production method offers only a medium level of control over the production process, which is therefore susceptible to problems and leads to quality issues of the grid and a suboptimal production yield.

Other fabrication methods include laser sintering of a two-dimensional grid of x-ray-absorbing septa from a metal powder bed and casting x-ray-absorbing material into a two-dimensional grid that is defined by a photolithography-produced mold. The mold can be made from a single piece or from stacked thin layers, while the filling material can be pure (e.g. liquid lead) or a mixture (e.g. of epoxy and tungsten powder). Two-dimensional grids offer superior scatter reduction, but these fabrication methods are costly for large anti-scatter grids and can often only be produced with a certain minimal thickness of the radiation-absorbing septa, typically greater than 100 μm. The latter makes the septa visible in high-resolution x-ray detectors and while correction algorithms have been developed, improvements may be made.

Example embodiments provide a method of manufacturing anti-scatter grids with almost arbitrary patterns, repeatability and high precision.

Anti-scatter grids according to example embodiments are more robust with respect to mechanical stability, humidity and temperature when compared to anti-scatter grids that are glued together.

Moreover, example embodiments allow for focused 2D anti-scatter grids without step-like structures. In some example embodiments, air is present between the x-ray-absorbing septa, resulting in better x-ray transmission. In contrast to example embodiments, however, where the wall thickness can be chosen freely between 1 and several hundred μm, both laser sintering and casting x-ray absorbing materials generally do not have wall thicknesses below 100 μm. This requirement makes them very heavy for large anti-scatter grids with high aspect ratio and makes the grid structure very well visible on high resolution detectors, which needs complicated algorithmic removal of the structures in the image post-processing.

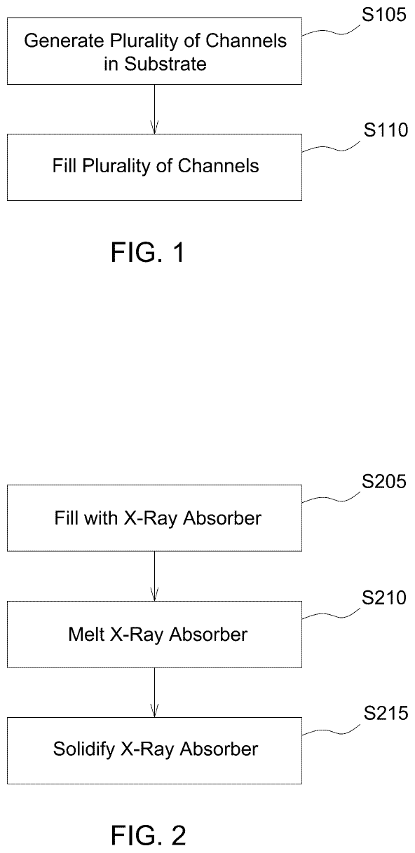

FIG. 1 illustrates a method of manufacturing an anti-scatter grid according to one or more example embodiments. At S105, a plurality of channels are generated in a substrate. While example embodiments are described with respect to a plurality of channels (e.g., 100 or more), it should be understood that the anti-scatter grid is not limited thereto. Moreover, while channels are illustrated as linear traversing along an axis in the width and/or length direction, the channels may be hexagonal apertures, cylindrical apertures, elliptical apertures, etc.

The substrate may be a rectangular plate of an x-ray transmitting material. The rectangular plate may have a height H, a width W and a length L where H<<W, L. In one or more example embodiments, the substrate is a glass rectangular plate where the glass includes at least one of borosilicate glass or fused silica glass.

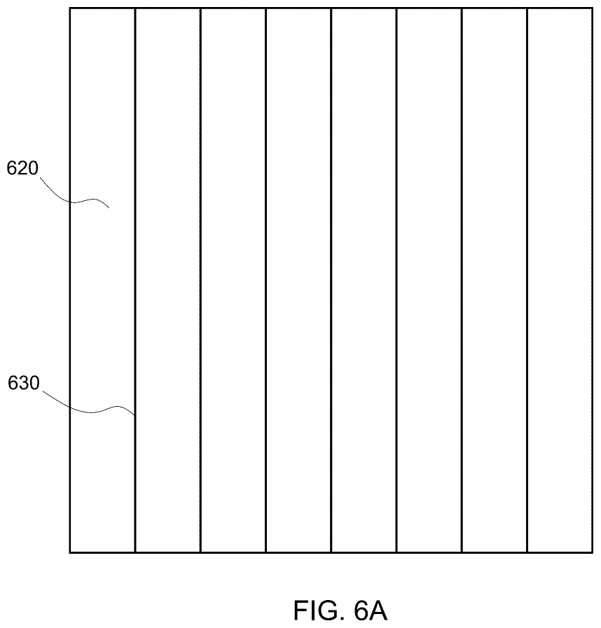

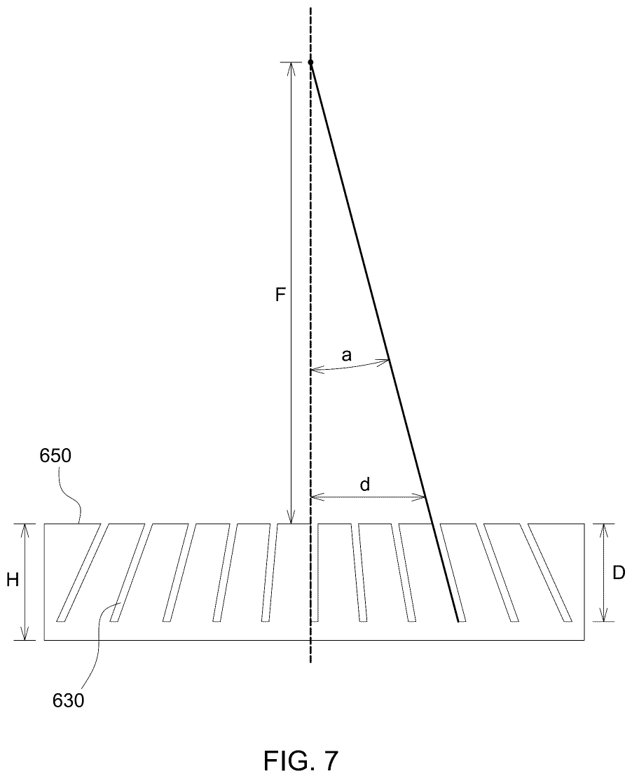

To generate the channels, the glass plate (i.e., the substrate) is patterned using a subtractive laser processing, such as inverse laser-drilling or selective laser-induced etching (SLE). SLE uses ultrashort laser pulses and subsequent wet etching to cut out rectangular grooves to form the plurality of channels from the substrate (see, e.g., FIG. 5). With SLE, the position and size of the focal spot in all three directions and the direction of the laser beam determine the processed volume that is subsequently removed by the wet etching. While the size of the focal spot is typically fixed before the start of the laser processing, the position of the focal spot, the direction of the laser beam and the laser intensity can be dynamically controlled to cut out arbitrary patterns from the glass plate. Thus, the plurality of channels may be one-dimensional (i.e., parallel lines) or two dimensional (e.g., lattice pattern (FIG. 7), circular pattern or any other pattern extending in two directions).

According to one or more example embodiments, the plurality of channels include a first number of channels (i.e., one or more) and a second number of channels (i.e., one or more), with the first number of channels extending in a first longitudinal direction and the second number of channels extending in a second longitudinal direction.

In at least some example embodiments, a Macro-SLE process may be used to generate the channels. In Macro-SLE, a lens with a larger focal distance (e.g., 80 - 160 mm) is used resulting in (i) a larger focal spot, e.g. 40 μm, that is the width of each channel (the diameter of the focal spot corresponds to the width of the channel); (ii) enlargement in the laser beam direction, allowing for deeper penetration in the substrate (e.g., a substrate of 3 mm height may be used with 100 micron layers being processed at a time in the substrate); and (iii) a speed at which the laser moves over the substrate (e.g., glass) is larger resulting in a faster process, and allows production of anti-scatter grids in about 1 hour instead of 100 hours and also reduces the machining costs by a factor of 100.

Other SLE processes may be used in other example embodiments. In other example embodiments, diamond wire sawing may be used instead of SLE.

In some example embodiments, each channel has a same width and in other embodiments the widths of the channels may vary. In some example embodiments, the widths of the channels are less than 150 μm. In other example embodiments, the widths of the channels are less than 100 μm. In some example embodiments, the widths of the channels are 40 μm. Due to the reduced widths of the channels (e.g., less than 100 μm), the channels are not visible in a high-resolution x-ray detector and eliminates the need for a correction algorithm to remove the channels from the x-ray detection.

The plurality of channels may be formed to extend entirely through the substrate (i.e., a depth D of the channels is the same as the height H of the substrate) or only partially through the substrate (i.e., a depth D of the channels is less than the height H of the substrate). The difference between the depth D of the channels and the height H of the substrate may be less than 1000 μm in some example embodiments and less than 500 μm in some example embodiments. The height H of the substrate may be 2-4 mm, e.g., 3 mm.

In an embodiment where the depth D of the channels is the same as the height H of the substrate, wet etching may be applied to opposing sides of the substrate.

At S110, after the plurality of channels are formed in the substrate using a laser, the plurality of channels are filled with an x-ray absorber.

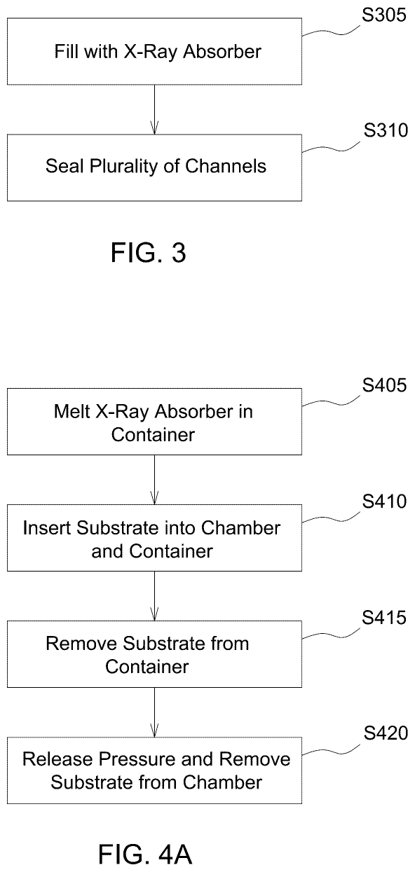

FIG. 2 illustrates a method of filling a plurality of channels in a substrate according to one or more example embodiments. As shown in FIG. 2, the channels are filled with an X-ray absorber in solid form at S205. In at least some example embodiments, the channels are filled with a powder X-ray absorber. In some example embodiments, the X-ray absorber may be tungsten, lead, or a combination of tungsten and a polymer.

At S210, the powder X-ray absorber in the channels is melted. In some example embodiments, the substrate and the X-ray absorber are heated at around 400° C., which melts the X-ray absorber, but not the glass substrate.

At S215, the melted X-ray absorber is solidified such as by a cooling process. In some example embodiments, a temperature of the substrate during the cooling process could be monitored with a sensor and controlled with the intensity of the lamp or local heating of a substrate holder.

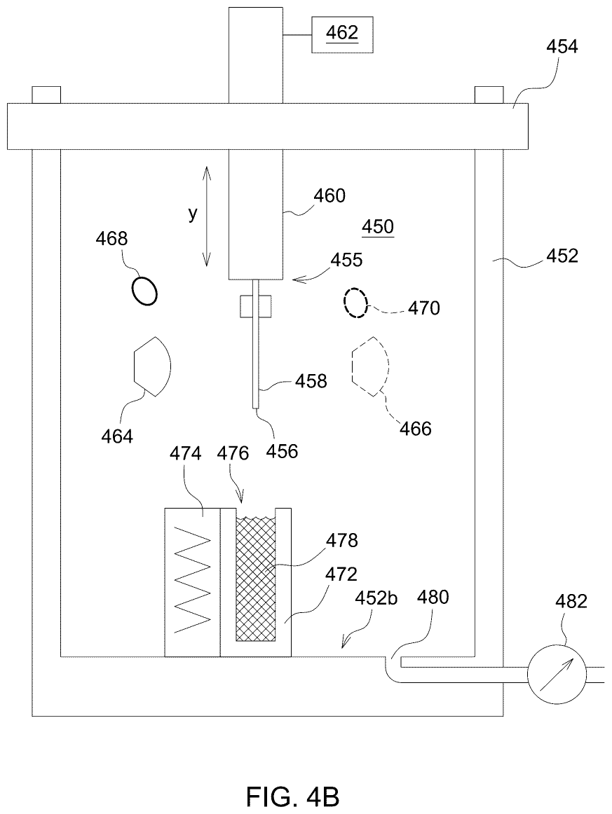

FIG. 3 illustrates another method of filling a plurality of channels in a substrate according to one or more example embodiments.

As shown in FIG. 3, the channels are filled with an X-ray absorber in solid form at S305. In at least some example embodiments, the channels are filled with a powder X-ray absorber. The X-ray absorber may be tungsten or lead.

At S310, the powder X-ray absorber in the channels is sealed with glue. In some example embodiments, the channels may be filled up with the X-ray absorber to about 10-20 μm below a top surface of the substrate and then the remaining 10-20 μm is filled up with liquid glue, e.g., by an ink jetting technique. The lower part of the channel would be closed by glass due to the depth D of the channel being less than the height H of the substrate. The glue is then cured by baking or UV light. In other example embodiments, the channels may be filled entirely with the X-ray absorber and a thin layer of glue may then be applied over the channels.

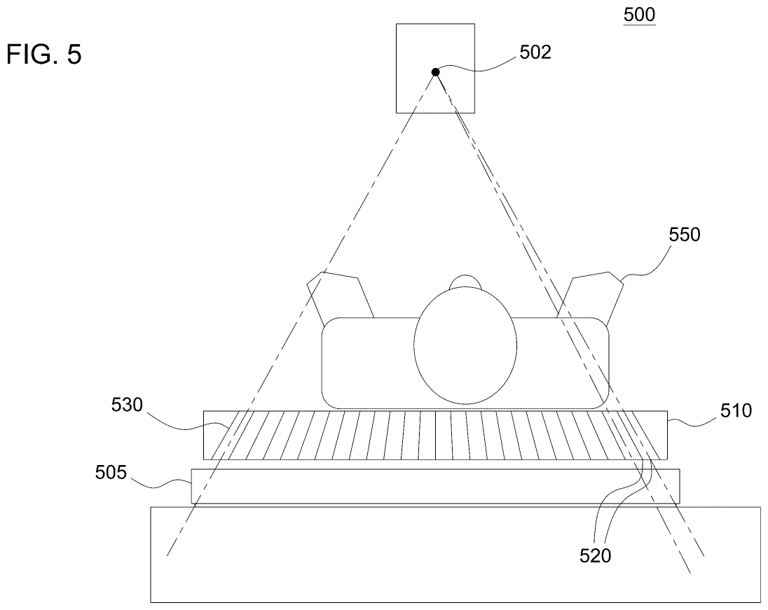

FIG. 4A illustrates another method of filling a plurality of channels in a substrate according to one or more example embodiments.

Referring to FIG. 4A, the channels may be filled by casting liquid x-ray absorber material into the channels and applying an external pressure during the casting. The process is similar as described in Roennebeck, Silke, “Untersuchungen zur Anwendung makropoösen Siliziums in der Röntgentechnik” (“Investigations on the application of macroporous silicon in X-ray technology”) (2001), the entire contents of which are incorporated by reference.

More specifically, the x-ray absorber material (e.g., lead) is liquified in a container in a chamber by heating the container and lead oxide on the surface of the liquified lead is removed at S405. At S410, the glass substrate with channels (after SLE) is inserted into the chamber. The chamber is then evacuated. The glass substrate is heated up to 450° C. by a lamp. The glass substrate is then inserted into the liquid lead and an external pressure between 0 and 10 bar is applied to the chamber (using, e.g., nitrogen gas). The glass substrate is taken out of the lead bath with the external pressure still applied to keep the lead inside the channels. The sample cools down by itself until the lead solidifies. The pressure is then released, and the glass substrate is removed from the chamber at S420. Residual drops of lead are scratched off of the surface of the glass substrate.

FIG. 4B illustrates a system for the implementation of the method shown in FIG. 4A. As shown in FIG. 4B, a system includes a chamber 450 defined by a body 452 and a cover 454. The body 452 may be cylindrical and made of a stainless steel, but is not limited thereto. Similarly, the cover 454 may be made of a stainless steel. The cover 454 is placed on top of the body 452 so as to enclose and seal the chamber 450.

A sample holder 455 holds a substrate 456 of x-ray transmitting material with etched channels in a vertical fashion such that the channels are exposed on a first side 458 of the substrate 456. The sample holder 455 is connected to a mount 460. The mount 460 extends from the chamber 450 and through the cover 454 to outside of the chamber 450. A seal is between the cover 454 and the mount 460 such that the chamber 450 can be pressurized when the cover 454 is secured to the body 452. A drive 462 actuates the mount 460 in an up and down direction (along the y-direction). The drive 462 may be pneumatic, electric (e.g., a motor) or other known systems. In other example embodiments, the sample holder 455 may extend through the mount 460 and the drive 462 may move the sample holder 455 while the mount 460 remains stationary.

The system further includes a heater 464 to heat the substrate 456. The heater 464 is mounted to the body 452 and located within the chamber 450. The system may further include a second heater 466 such that two opposing sides are evenly heated. The heaters 464 and 466 may be UV lamps with a wavelength less than or equal to 300 nm or infrared lamps with a wavelength greater than or equal to 2000 nm. Each of the heaters 464 and 466 may have a mirror to amplify the heat directed to the substrate 456. In other example embodiments, visible light heater may be used and a coating that absorbs visible light may be applied to the surfaces of the substrate 456.

The system may further include an infrared camera 468 to monitor the temperature and homogeneity of the temperature distribution within the substrate 456. The system may further include a second infrared camera 470 so as to have a line of sight to the first side 458, in addition to the opposing side of the substrate 456.

Located at a bottom 452b of the body 452 is a container 472 and a heater 474. The container 472 contains an x-ray absorbing material 478 and has an open end 476 that is exposed to the sample holder 455 and mount 460. The open end 476 is aligned with the substrate 456 such that when the mount 460 and/or the sample holder 455 is moved toward the bottom 452b, the substrate 456 is inserted into the x-ray absorbing material 478. The heater 474 is adjacent to the container 472 such that the heater 474 heats the x-ray absorbing material 478 (e.g., lead or tungsten, but not limited thereto) into a liquid state. The heater 474 may be a heating plate.

A port 480 extends from the bottom 452b through the body 452 to a pump 482. The pump 482 is located external to the body 452. The pump 482 is configured to pressurize the chamber 450 (e.g., with nitrogen up to 10 bar).

The x-ray absorbing material 478 is heated until molten. Oxides are then removed from the surface of the liquid. After mounting the substrate 456 into the sample holder 455, the cover 454 is closed, and the chamber 450 is evacuated using the pump 482. After conditioning the substrate 456 to a temperature close to the temperature of the liquid x-ray absorbing material (e.g., 330°C. to 450° C.) by the heater 464, the substrate 456 is lowered into the x-ray absorbing material 478 and a nitrogen pressure of a few bar (e.g., up to 10 bar) is applied to force the liquid x-ray absorbing material 478 into the channels.

When the substrate 456 is lifted out of the liquid x-ray absorbing material 478, the liquid x-ray absorbing material 478 cools down to below the melting point of lead, while the pressure is still applied. After the x-ray absorbing material 478 solidifies, the pressure within the chamber 450 is relieved and after further cool down, the chamber 450 is opened, and the substrate 456 is taken out of the sample holder 455. The substrate 456 may then be cleaned, if needed.

Referring back to FIG. 1, in other example embodiments, the channels may be filled with lead lamellae with thickness corresponding to the width of the grooves at S110.

FIG. 5 illustrates a medical system according to one or more example embodiments.

As shown in FIG. 5, a medical system 500 includes a radiation source 502 (e.g., x-ray source), a radiation detector 505 and an anti-scatter grid 510. The medical system 500 may include additional elements and is not limited to the elements shown in FIG. 5.

The radiation source 502 is configured to transmit radiation to a patient 550 and the radiation detector 505 is configured to detect at least a portion of the transmitted radiation. The radiation detector 505 is used for obtaining an image of the patient 550 and can be a digital radiography (DR) receiver, for example, an indirect flat panel detector.

The anti-scatter grid 510 may be made using the method of FIG. 1. The anti-scatter grid 510 may be a substrate including x-ray transmitting portions 520 (e.g., including at least one of borosilicate glass or fused silica glass). Within the substrate are a plurality of channels 530 filled with x-ray absorbing material.

The x-ray transmitting portions 520 extend through the anti-scatter grid 510 and substantially converge toward a focal point, shown as the radiation source 502. The x-ray transmitting portions 520 permit the portion of transmitted radiation to reach the radiation detector 505.

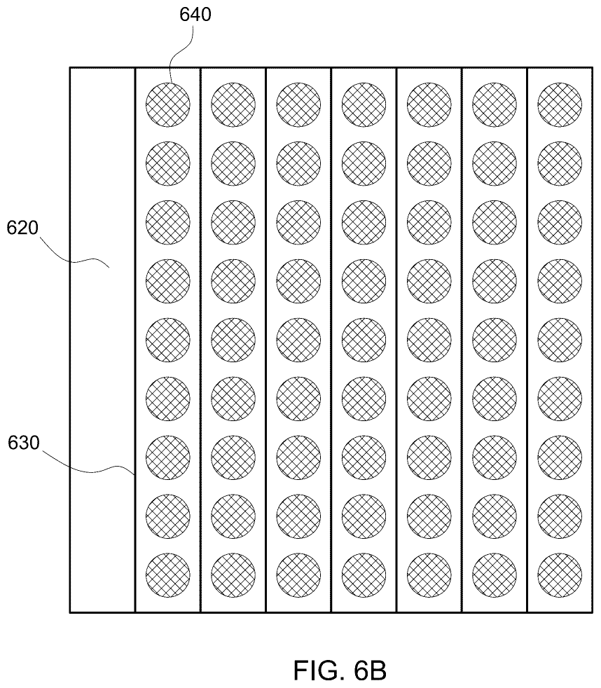

FIG. 6A illustrates a top view of a one-dimensional anti-scatter grid according to one or more example embodiments. FIG. 7 illustrates a cross-sectional view of the anti-scatter grid of FIG. 6A without an x-ray absorbing material, according to one or more example embodiments.

An anti-scatter grid 600 may be the same as the anti-scatter grid 510 and may be made using the method of FIG. 1. The anti-scatter grid 600 may be a substrate including x-ray transmitting portions 620 (e.g., including at least one of borosilicate glass or fused silica glass). Within the substrate are a plurality of channels 630 filled with x-ray absorbing material.

The channels 630 are arranged generally parallel to a longitudinal axis of the anti-scatter grid 600, but generally inclined to one another to form a focused geometric grid. Each channel 630 is between two x-ray transmitting portions 620.

The pattern of the channels 630 are parallel lines of depth D and at angles α to a surface normal 650 that are consistent with the focal distance F of the anti-scatter grid 600 and a distance from the center of the glass plate d such that tan(α)=d/F. The focal distance may be between 50-200 cm, for example. Focal distance is further described in, https://www. upstate.edu/radiology/education/rsna/radiography/scattergrid.php (last accessed Sep. 24, 2024), the entire contents of which are incorporated by reference.

FIG. 6B illustrates a top view of a one-dimensional anti-scatter grid according to one or more example embodiments.

As shown in FIG. 6B, the anti-scatter grid further includes holes 640 (of air) extending through the x-ray transmitting portions 620 to increase the transmission for x-rays. The holes 640 may be created by milling out the x-ray transmitting portions after the casting of the x-ray absorbing material. In some example embodiments, the holes 640 may be generated by laser drilling with many parallel beams. In other example embodiments, SLE could be used, and a passivation layer may be applied to the channels 630 for protection during the SLE process.

In other example embodiments, the holes 640 may be generated prior to the casting of the x-ray absorbing material. For example, laser cutting would be done with SLE in parallel or in series with the generation of the channels. The additional cut-out glass (i.e., the holes) would certainly be blind holes that are open at a first side, while the channels are open only to a second side opposing the first side (also blind holes, but to the other side). The holes 640 would not extend through the entire height of the substrate. For the lead casting process, the blind holes on first side are closed with a Kapton foil (glued or pressed) that withstands high temperatures and pressure.

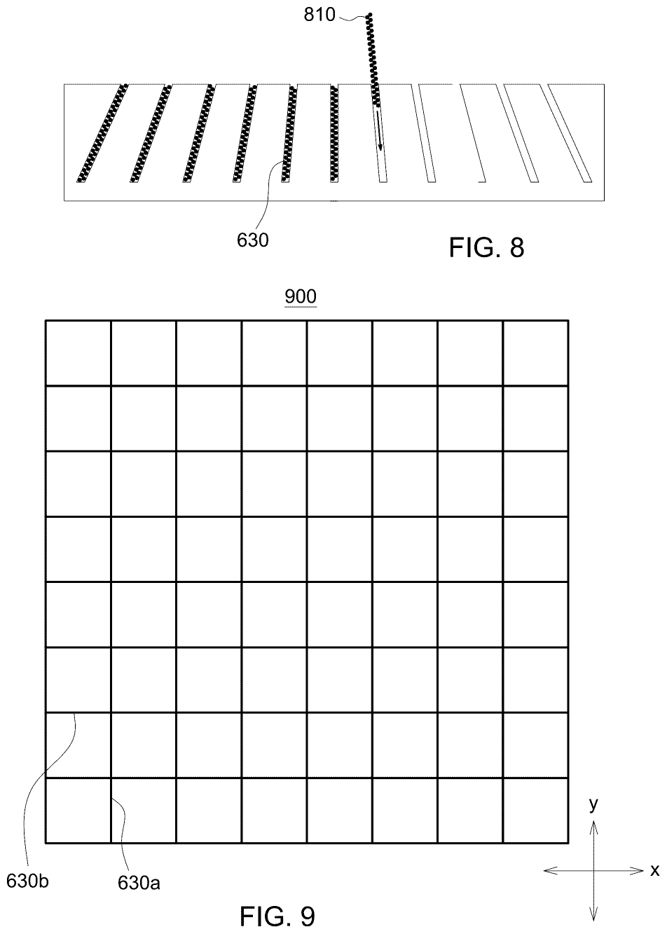

FIG. 8 illustrates a method of filling the anti-scatter grid shown in FIG. 5 with the x-ray absorbing material, according to one or more example embodiments. As shown in FIG. 8, the channels 630 are filled with lead powder 810. The lead powder may be balls having a diameter between 1-20 μm. In some example embodiments, the lead powder is subsequently baked. In other example embodiments, the lead powder is subsequently sealed with a glue.

FIG. 9 illustrates a top view of a two-dimensional anti-scatter grid according to one or more example embodiments. As shown, an anti-scatter grid 900 includes a first plurality of channels 630a and a second plurality of channels 630b. The first plurality of channels 630a extend along a first axis (e.g., the y-axis) and the second plurality of channels 630b extending along a second axis (e.g., the x-axis).

The pattern of FIG. 9 consists of two such one-dimensional patterns crossing at an 90° angle. However, example embodiments are not limited thereto. For example, the first plurality of channels 630a and the second plurality of channels 630b may intersect at angles different than 90°. In the literature this grid is referred to as a two-dimensional (focused) grid and such grids are typically produced by the new fabrication methods.

The production techniques described above allow the production of grids with arbitrary patterns in stable and well-controlled processes from clean bulk material.

None of the elements recited in the claims are intended to be a means-plus-function element within the meaning of 35 U.S. C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific structural and functional details disclosed herein are merely representative for purposes of describing example embodiments. This invention may, however, be embodied in many alternate forms and should not be construed as limited to only the embodiments set forth herein.

### NON-LIMITING ILLUSTRATIVE EMBODIMENTS

The following is a list of non-limiting illustrative embodiments disclosed herein:

Illustrative embodiment 1 includes an anti-scatter apparatus comprising a substrate including an x-ray transmitting material, the x-ray transmitting material including at least one of borosilicate glass or fused silica glass, the substrate defining a plurality of channels therein; and an x-ray absorbing material in the plurality of channels.

Illustrative embodiment 2 includes the anti-scatter apparatus of illustrative embodiment 1, wherein the plurality of channels include a first plurality of channels and a second plurality of channels, the first plurality of channels extending along a first axis and the second plurality of channels extending in a second axis.

Illustrative embodiment 3 includes the anti-scatter apparatus of any one of illustrative embodiments 1 and 2, wherein a width of a channel of the plurality of channels is less than 100 μm.

Illustrate embodiment 4 includes a method of manufacturing an anti-scatter apparatus, the method comprising generating a plurality of channels in a substrate using a laser, the substrate including an x-ray transmitting material; and filling the plurality of channels with an x-ray absorber material.

Illustrative embodiment 5 includes the method of illustrative embodiment 4, wherein a width of a channel of the plurality of channels is less than 100 μm.

Illustrative embodiment 6 includes the method of illustrative embodiment 5, wherein the width of the channel of the plurality of channels is less than 50 μm.

Illustrative embodiment 7 includes the method of any one of illustrative embodiments 4, 5 and 6, wherein the substrate includes a glass.

Illustrative embodiment 8 includes the method of illustrative embodiment 7, wherein the glass includes at least one of borosilicate glass or fused silica glass.

Illustrative embodiment 9 includes the method of any one of illustrative embodiments 4-8, wherein the generating includes at least one of inverse laser-drilling to form a plurality of grooves in the substrate; or applying laser pulses to form the plurality of grooves in the substrate.

Illustrative embodiment 10 includes the method of any one of illustrative embodiments 4-9, wherein the generating includes the applying the laser pulses and further includes wet etching the plurality of grooves to form the plurality of channels.

Illustrative embodiment 11 includes the method of any one of illustrative embodiments 4-9, wherein the filling includes, filling the plurality of channels with the x-ray absorber material in a solid form; melting the solid x-ray absorber material; and subsequently solidifying the melted x-ray absorber material.

Illustrative embodiment 12 includes the method of any one of illustrative embodiments 4-11, wherein the x-ray absorber material in the solid form is a powder.

Illustrative embodiment 13 includes the method of any one of illustrative embodiments 4-10, wherein the filling includes, filling the plurality of channels with the x-ray absorber material in a solid form; and sealing the plurality of channels after the filing the plurality of channels with the x-ray absorber material in the solid form.

Illustrative embodiment 14 includes the method of any one of illustrative embodiments 4-10 and 13, wherein the x-ray absorber material in the solid form is a powder.

Illustrative embodiment 15 includes the method of any one of illustrative embodiments 4-10, wherein the filling includes casting the x-ray absorber material in a liquid form into the plurality of channels.

Illustrative embodiment 16 includes the method of illustrative embodiment 15, wherein the filling further includes applying an external pressure during the casting.

Illustrative embodiment 17 includes the method of any one of illustrative embodiments 4-10, wherein the filling fills each of the plurality of channels with a lamellae of the x-ray absorber material, a thickness of each lamellae corresponding to a width of the plurality of channels.

Illustrative embodiment 18 includes a medical system comprising a radiation source configured to transmit radiation to a subject; a radiation detector configured to detect at least a portion of the transmitted radiation; and an anti-scatter grid, the anti-scatter grid including, a substrate including an x-ray transmitting material to permit the portion of the transmitted radiation to reach the radiation detector, the x-ray transmitting material including at least one of borosilicate glass or fused silica glass, the substrate defining a plurality of channels therein, and an x-ray absorbing material in the plurality of channels.

Illustrative embodiment 19 includes a method of manufacturing an anti-scatter apparatus, the method comprising generating a plurality of channels in a substrate using wire sawing, the substrate including an x-ray transmitting material; and filling the plurality of channels with an x-ray absorber material.

What is claimed is:

1. An anti-scatter apparatus comprising:
a substrate including an x-ray transmitting material, the x-ray transmitting material including at least one of borosilicate glass or fused silica glass, the substrate defining a plurality of channels therein; and
an x-ray absorbing material in the plurality of channels.

2. The anti-scatter apparatus of claim 1, wherein the plurality of channels include a first plurality of channels and a second plurality of channels, the first plurality of channels extending along a first axis and the second plurality of channels extending in a second axis.

3. The anti-scatter apparatus of claim 1, wherein a width of a channel of the plurality of channels is less than 100 μm.

4. A method of manufacturing an anti-scatter apparatus, the method comprising:
generating a plurality of channels in a substrate using a laser, the substrate including an x-ray transmitting material; and
filling the plurality of channels with an x-ray absorber material.

5. The method of claim 4, wherein a width of a channel of the plurality of channels is less than 100 μm.

6. The method of claim 5, wherein the width of the channel of the plurality of channels is less than 50 μm.

7. The method of claim 4, wherein the substrate includes a glass.

8. The method of claim 7, wherein the glass includes at least one of borosilicate glass or fused silica glass.

9. The method of claim 4, wherein the generating includes at least one of,
inverse laser-drilling to form a plurality of grooves in the substrate; or
applying laser pulses to form the plurality of grooves in the substrate.

10. The method of claim 9, wherein the generating includes the applying the laser pulses and further includes wet etching the plurality of grooves to form the plurality of channels.

11. The method of claim 4, wherein the filling includes,
filling the plurality of channels with the x-ray absorber material in a solid form;
melting the solid x-ray absorber material; and
subsequently solidifying the melted x-ray absorber material.

12. The method of claim 11, wherein the x-ray absorber material in the solid form is a powder.

13. The method of claim 4, wherein the filling includes,
filling the plurality of channels with the x-ray absorber material in a solid form; and
sealing the plurality of channels after the filing the plurality of channels with the x-ray absorber material in the solid form.

14. The method of claim 13, wherein the x-ray absorber material in the solid form is a powder.

15. The method of claim 4, wherein the filling includes,
casting the x-ray absorber material in a liquid form into the plurality of channels.

16. The method of claim 15, wherein the filling further includes,
applying an external pressure during the casting.

17. The method of claim 4, wherein the filling fills each of the plurality of channels with a lamellae of the x-ray absorber material, a thickness of each lamellae corresponding to a width of the plurality of channels.

18. A medical system comprising:
a radiation source configured to transmit radiation to a subject;
a radiation detector configured to detect at least a portion of the transmitted radiation; and
an anti-scatter grid, the anti-scatter grid including,
a substrate including an x-ray transmitting material to permit the portion of the transmitted radiation to reach the radiation detector, the x-ray transmitting material including at least one of borosilicate glass or fused silica glass, the substrate defining a plurality of channels therein, and
an x-ray absorbing material in the plurality of channels.

19. A method of manufacturing an anti-scatter apparatus, the method comprising:
generating a plurality of channels in a substrate using wire sawing, the substrate including an x-ray transmitting material; and
filling the plurality of channels with an x-ray absorber material.
